(19) United States
(12) Patent Application Publication
(10) Pub. No.: US 2015/0150411 A1
(43) Pub. Date: Jun. 4, 2015

(54) AIRCRAFT KETTLE TEMPERATURE CONTROL SYSTEM

(71) Applicant: RICHARDS CORPORATION, Sterling, VA (US)

(72) Inventors: Abdelaziz Boubeddi, Ashburn, VA (US); Brian M. Joyce, Leonardtown, MD (US); Paul Aquire, Fairfax, VA (US); Koffi Mawule, Silver Spring, MD (US)

(21) Appl. No.: 14/093,545

(22) Filed: Dec. 2, 2013

(51) Int. Cl. A47J 31/56

(52) U.S. Cl. CPC A47J 31/56

(57) ABSTRACT

Embodiments of the present invention provide a kettle for use on-board aircraft that detects and measures a change in temperature in order to determine the point at which liquid in the kettle is boiling and to turn off the heater.

### FIELD OF THE INVENTION

Embodiments of the present invention relate generally to kettles, and specifically, to kettles for use at varying altitudes. Specific embodiments relate to kettles for use on-board aircraft that measure a change in temperature in order to determine the point at which liquid in the kettle is boiling at any altitude/pressure and to turn off the heater.

### BACKGROUND

Water boils at different temperatures, depending upon whether the boiling location is at sea level, above sea level, or below sea level. This boiling temperature difference is particularly noticeable for technologies related to aircraft beverage makers, which are intended for use at any number of varying altitudes. As the aircraft's attitude increases, air density decreases, causing pressure to decrease. As the pressure drops, the temperature at which water boils decreases. For example, under normal barometric conditions at sea level, the boiling point of water is 212 degrees Fahrenheit, 100.3 degrees Celsius. For every 500-foot increase in elevation, the boiling point generally drops about 0.9 degree Fahrenheit. Thus, at a city of 5,000 feet above sea level, water boils at about 201 degrees Fahrenheit. At approximately 10,000 feet above sea level, water boils at about 194 degrees Fahrenheit and so forth.

The ideal temperature for hot water for coffee or tea is about 200 degrees Fahrenheit, which is the temperature at which most residential and commercial drip coffee makers operate. However, even though kettles and coffee makers on an aircraft are sometimes operated on the ground (e.g., while tea is being served pre-flight), as well as at high altitudes (e.g., during in-flight service), and even though water has a substantially higher boiling point on ground, safety considerations have generally required kettles for heating water used on board aircraft to be universally configured to heat at the in-flight lower/safer temperatures. Because water boils at a lower temperature at higher fight altitudes, the kettle temperature set-points are set below the boiling point at these altitudes in order to prevent constant boiling in the hot water brewer tanks when the aircraft is in flight.

As such, most aircraft kettles are permanently set to heat water to a point below the optimal in-flight temperature, without regard to the atmospheric pressure or altitude of the aircraft, which results in kettles that do not brew at the optimal temperature when the aircraft is on ground. One type of aircraft kettle reads the actual temperature of the water in the kettle, and once a certain temperature has been met, the kettle stops heating. However, as discussed above, these systems can create less than optimal tasting beverages if the aircraft is at an altitude with a different boiling temperature than the brewing set temperature. Various other temperature-adjusting features for kettles (and coffee makers) intended for operation at varying altitudes have been designed, one example of which is described in co-pending U.S. application Ser. No. 12/887,796, titled “Automatically Adjusting Coffee Makers,” filed Sep. 22, 2010, which is a coffee maker that receives altitude information from the aircraft and automatically adjusts brewing temperatures. However, additional and alternate improvements are desirable.

### BRIEF SUMMARY

Embodiments of the invention described herein thus provide aircraft kettles that measure a change in temperature in order to determine the point at which liquid in the kettle is boiling at any altitude/pressure and to turn off the heater.

### BRIEF DESCRIPTION OF THE DRAWINGS

FIG. 1 shows a schematic view of a temperature plateau measured by the embodiments described herein.

FIG. 2 shows a side perspective view of one embodiment of a kettle.

FIG. 3 shows a lower perspective view of one embodiment of a kettle.

### DETAILED DESCRIPTION

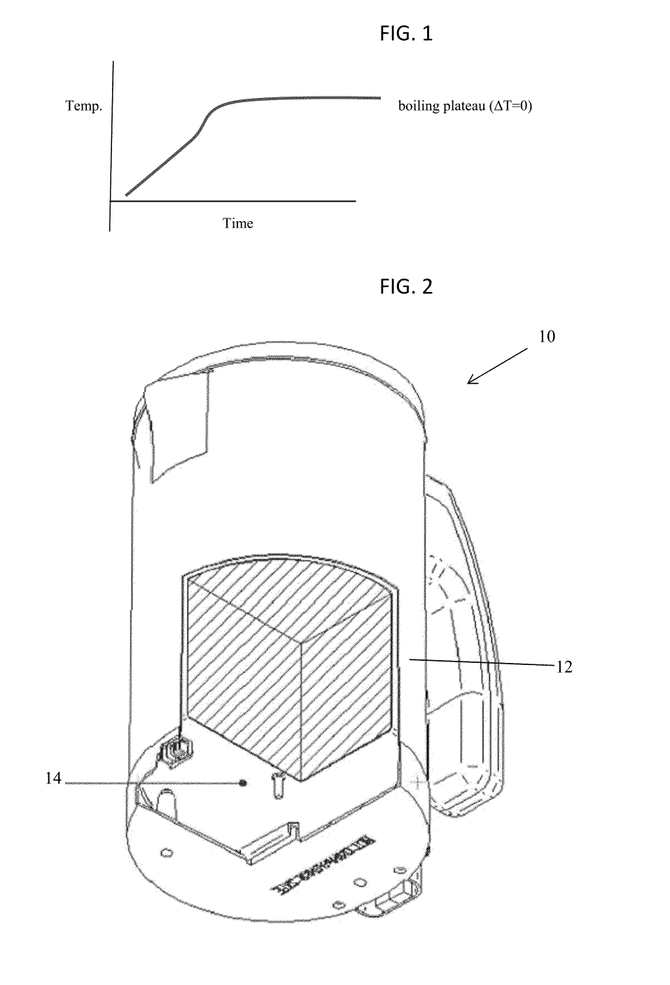

Embodiments of the present invention provide an aircraft kettle that measures the temperature change of the water in the kettle over a specified period of time. Once the temperature change (ΔT) reaches zero, this means that the water is boiling (as it is no longer rising in temperature; there is no temperature change), and the kettle shuts off. Rather than being set at a certain temperature, the present kettle actually determines whether the water is boiling, a state which can be reached at different temperatures at different altitudes/pressures. In other words, once the water boils, it plateaus by reaching a steady state, as shown in FIG. 1. Once the temperature reaches the boiling plateau, there is no longer a temperature change, such that the ΔT=0.

Accordingly, there is a provided an aircraft kettle 10 that measures the ΔT over time and once the ΔT plateaus for a certain period of time (or gets close to zero), then the kettle shuts off. This ΔT=0 means that the water is boiling and that no further heating is necessary. This allows the kettle to boil water at any altitude without have an arbitrary required pre-set temperature. Instead, it can brew more safely (by not boiling at too high a temperature for too long) but can also produce water of the optimal temperature.

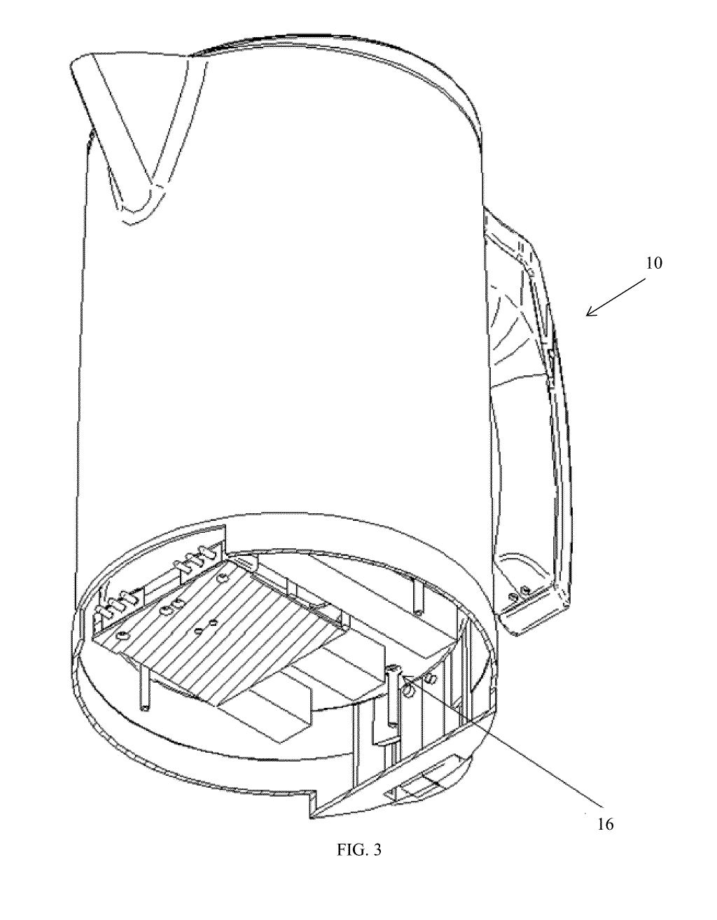

In the embodiment shown in FIG. 2, the aircraft kettle 10 is designed for use with an aircraft beverage maker or coffee maker. The kettle is insulated, such that once the heater is turned off and the water stops boiling, the kettle keeps the heat inside the carafe. In one embodiment, the kettle 10 has an inner liner 12, which is designed to keep the liquid contained within the kettle warm. A temperature sensor 14 may be provided in relation to the inner liner 12. In one embodiment, the sensor 14 may be a surface temperature sensor that measures the temperature of the inner liner. In the embodiment shown, the temperature sensor is positioned on the outside of the inner liner 12, but it may be provided at other locations.

For example, in one embodiment, the temperature sensor may be located on the bottom of the kettle, as that location of the inner liner will most likely be in contact with water during the boil. Sensor 14 is shown positioned at the bottom of the liner, and in some embodiments, this has been found to be the optimal position. However, the sensor may be positioned elsewhere if desired and/or determined necessary. The primary function of temperature sensor 14 is to measure the temperature of either the liner, the liquid contained therein, or both, in order to determine the ΔT. A measurement of the inner liner temperature will closely reflect the temperature of the water, if present. When water is present in the kettle 10, the temperature of the inner liner 12 is similar to that of the water. When the water reaches boiling, it will no longer increase in temperature, and the same is true of the inner liner 12. Thus, by measuring the temperature of the inner liner 12, the temperature of the water is also being measured. When the liner reaches a ΔT of zero, this indicates to the heater to turn off. If the water contained in the kettle should be re-heated, the system may be turned back on and the system will be set to boil again until the ΔT reaches zero again.

There are also safety algorithms included in the system so that if the system is on with low water, the temperature change will spike quickly (more quickly than if water were present), so that they system will shut off. In one embodiment, a controller system measures the ΔT (which is the final temperature minus the initial temperature) over a predetermined set time (t) in order to calculate a variable X in the equation ΔT/t=X. The predetermined set time (t) may be determined by determining how long the water should boil (and stay at the boiling point) to ensure a uniform heating temperature throughout the kettle. This may differ based on the size of the kettle, but range options include any number of seconds, which is dependent upon and can vary based on power and kettle capacity. One goal may be about 5-10 seconds, but longer and shorter times are possible and considered within the scope of this disclosure.

The general goal is to allow the liquid to boil long enough that it is uniformly heated, but not so long as to overheat the heaters or use undue power. In some higher altitudes, it has been found preferable to allow the water to heat for 2 or 3 seconds (and sometimes longer) past the point at which ΔT has been determined to plateau, in order to ensure that the temperature truly has plateaued.

This variable X is then compared to a predetermined Y in the equation X≦Y to determine whether the water is boiling. The predetermined Y may differ based on a number of factors, including but not limited to wattage, liner material and thickness. If the water is determined to be boiling, then the unit will shut off. (The design of the kettle 10 and inner liner 12 will keep the water hot for an extended period of time once the heating of the unit has been turned off.) This equation is applied to the dry boil protection for no water being present. When an insufficient amount of water is present, the increase in temperature will be faster than when water is present. If X≧Z (with Z being a predetermined number, generally based on situations of low water, boil off, and dry boil), the controller will turn off the kettle. The Y and Z numbers may vary based on the design factors of the kettle.

One design of the kettle may provide a thermocouple 16 that is attached at the bottom of the kettle, as shown in FIG. 3.

Measuring the ΔT in this way has been found to be an optimal solution to just providing a set temperature point at which a mechanical system stop pops or bends to turn the system off once that set temperature has been reached, due to the pressure differentials experienced by an aircraft cabin. One problem with these “temperature set” systems is that if the aircraft is on ground, the water will never boil and the beverage will not taste as rich or flavorful. Another downside is that they are usually set to the minimum temperature so they are always hot or boiling, no matter what. There is not a system, set to detect when the temperature has plateaued, such that the boiling heat is no longer needed. The presently described system is also optimal to providing a system that maintains an “on” position continuously, which can cause the kettle to overheat, burning the heater and wasting power.

Changes and modifications, additions and deletions may be made to the structures and methods recited above and shown in the drawings without departing from the scope or spirit of the invention and the following claims.

What is claimed is:

1. A kettle configured for use at varying altitudes, comprising
(a) a kettle body;
(b) a temperature sensor associated with the kettle body; and
(c) a system configured to detect a temperature plateau state of liquid contained within the kettle body.

2. The kettle of claim 1, wherein the system configured to detect the temperature plateau state cooperates with a heater controller.

3. The kettle claim 1, wherein the kettle body has an inner liner configured to maintain the temperature of liquid contained with the kettle body at a desired temperature for a period of time.

4. The kettle of claim 1, wherein the temperature sensor is positioned outside the inner liner.

5. The kettle of claim 1, wherein the kettle body has a handle.

6. The kettle of claim 1, wherein the system is configured to detect a change in temperature as a function of time.

7. A method for improving kettle function at varying altitudes, comprising:
(a) providing a kettle of claim 1;
(b) measuring the change in temperature over a period of time;
(c) determining when change in temperature plateaus for a certain period of time;
(d) shutting of the kettle when the change in temperature reaches zero.

8. The method of claim 7, wherein the change in temperature is measured by a temperature sensor located on the bottom of the kettle.
